(19) United States
(12) Patent Application Publication
(10) Pub. No.: US 2013/0332829 A1
(43) Pub. Date: Dec. 12, 2013

(54) DYNAMIC 2D AND 3D GESTURAL INTERFACES FOR AUDIO VIDEO PLAYERS CAPABLE OF UNINTERRUPTED CONTINUITY OF FRUITION OF AUDIO VIDEO FEEDS

(71) Applicants: Filippo Costanzo, Los Angeles, CA (US); Antonio Rossi, Rome (IT)

(72) Inventors: Filippo Costanzo, Los Angeles, CA (US); Antonio Rossi, Rome (IT)

(21) Appl. No.: 13/981,058

(22) PCT Filed: Jan. 20, 2012
(86) PCT No.: PCT/US12/22088

§ 371 Date: Aug. 13, 2013

Related U.S. Application Data
(60) Provisional application No. 61/435,277, filed on Jan. 22, 2011.

(51) Int. Cl. G06F 3/01

(52) U.S. Cl. CPC G06F 3/017
USPC 715/716

(57) ABSTRACT

A method of manipulating a audio video visualization in a multi dimensional virtual environment implemented in a computer system having a display unit for displaying the virtual environment and a gesture driven interface, said method manipulating the visualization in response to predetermined user gestures and movements identified by the gesture driven interface.

### CROSS-REFERENCE TO RELATED APPLICATION

This application claims the benefit of PCT Application No. PCT/US2012/022088, entitled “Dynamic 2D And 3D Gestural Interfaces For Audio Video Players Capable Of Uninterrupted Continuity Of Fruition Of Audio Video Feeds” filed Jan. 20, 2012, which claims the benefit of U.S. Provisional Patent Application No. 61/435,277, entitled “Dynamic 2D And 3D Gestural Interfaces For Audio Video Players Capable Of Uninterrupted Continuity Of Fruition Of Audio Video Feeds” filed Jan. 22, 2011, the contents of which are incorporated by reference herein in its entirety.

### FIELD OF THE INVENTION

The present invention relates to remote control devices, more specifically to a remote control for portable electronic devices that is simple operate and operable with a single hand.

### BACKGROUND

Gestural interfaces have gained increased popularity in the last few years. Consumer electronics manufacturers such as Nintendo, Apple, Nokia, Sony Ericsson, LG, and Microsoft have all released products that are controlled using interactive gestures.

It is foreseeable that hundreds of millions of devices will soon have such interfaces. “Gesture” is considered any physical movement that an analog or digital system can sense and respond to without the aid of a interposed pointing device such as a mouse etc. . . .

Current videogames interfaces already use free-form gestures to allow players to make movements in space that are then reflected in on-screen actions while Apple's iPhone and iPad employ touch screen devices that users control via a tap or a swipe of their fingertips.

Other categories of hardware devices incorporating gesture driven interfaces can be found in videogames market; game consoles like the Microsoft xBox 360 use specific hardware (kinect) capable of reading the user gestures through a sophisticated implementation of image recognition techniques and augmented (3D depth) camera acquisition.

It is also foreseeable that these capabilities might expand in the future to other appliances beyond the realm of video-games consoles. Apple is currently selling a device named “Apple TV”, which in the next version of the iOS operating system (should be version numbered 4.3 at the moment of writing) will be capable of receiving, via wireless connection, audio-video content to be shown on TV screens using eventually an iPhone/iPod/iPad hand-held device to serve as an enhanced remote control for Apple TV's user interface. It can be easily imagined that such class of devices (Apple TV or Google TV, and so on) could also have, in the near future, the capability of receiving user input through a gestural interface that could be driven by an hardware comparable to the xBox 360 kinect mentioned above.

It is interesting to notice that at the present time, gestural interfaces are mostly exploited in specific application domains such web surfing, phone functions and games.

These same interfaces are still grossly underutilized in the audio-video production and fruition domains, with the exception of few very basic level implementations. This might be caused perhaps by the traditional assumption that considers audio-video content as a passive form of entertainment generally capable of a very low level of interaction. On that note, possibly only the invention of the remote control could be considered as one of the significant milestones of the past few decades. As an example, audio-video players are currently available on the Apple iPhone/iPad/iPod class of devices. Yet there has been no substantial enhancement to the user-experience given by the available gestural interface capabilities as most of the functionality seems limited to a classic “play”, “pause”, “stop” etc.

In the preferred embodiment described in the present document we are showing an example of an application developed for Apple iPad, said application is taking full advantage of the gestural interface capabilities available in said device.

The same concepts here presented are anyway easily transferred to other environments by a person that is ordinarily skilled in the art. Such environments may include the aforementioned xBox 360 kinect system, and possibly to all the other cases of gestural enabled hardware.

### SUMMARY OF THE INVENTION

This invention relates to a class of enhanced audio-video players capable of providing the experience of watching a nearly unlimited number of available audio-video feeds (pertaining to an event) from which the desired one can be interactively chosen, at any given moment, by the user, while the uninterrupted continuity of fruition of audio and video is maintained.

Possible embodiments of such players include on-screen playback choice of audio-video feeds of an event; the feeds pertaining to a discrete number of audio and video sources available for said event.

Other embodiments may include said discrete audio and video sources as well as a number of virtually unlimited vantage points of view obtained by: 1. the interpolation of said sources via real-time (or offline) 3D reconstruction and frame-rate coherent rendering of the scene 3D geometry pertaining to the event being depicted, 2. augmented audio-visual capture systems capable of acquiring full tridimensional information of an event at the desired sample rates. Therefore such players may provide a virtually unlimited number of viewpoint choices beyond the discrete limitation of the original source audio and video material. Said class of players might be used on a variety of digital devices and operate with local and/or streamed audio and video feeds.

The preferred embodiment of the present invention is related to said Apple devices, but the same concepts and methods could be easily applied to other environment, such for example Android based smart-phones and/or tablets, or other products as well.

The purpose of this invention is to create an interactive method of informing a gestural interface so to provide the user with the experience of effectively transitioning inside the tridimensional space of the scene while choosing the desired vantage point of view in the audio-video player. The results might then be displayed on a screen or on a comparable 2D and 3D display device.

Furthermore the present invention aims to provide the user with the feeling of “being there”, placing her/him inside a simulated environment (for example a Theatre) in which she/he can choose from virtually unlimited points of views and (if available) listening positions.

The interaction between the user and the content (via the gestural interface) is extended to every element presented during the show; for example, in the preferred embodiment, the concurrent time-coding data processing also allows the user to exploit the gestural interface to “perform” as a “virtual director”—altering the timing of the audio-video feeds as in a slow motion effect, or as a “virtual conductor”—altering the tempo of an orchestra musical performance without modifying the audio pitch.

Imagine watching a symphonic orchestral performance during which you might be able—via an advanced gestural interface—to transition among multiple available vantage points of view indicating the direction and position the camera should move. You could experience the auditory environment as it would be perceived close to the violins or near the brass section. Furthermore you could as well, mimicking the gestures of an orchestra conductor, modify the execution by altering the tempo (“plano”, “andante”, “presto” etc. . . . ) of the musical performance and the loudness level.

For a definition of audio pitch please see: http://en.wikipedia.org/wiki/Pitch_(music).

Another source of a very powerful audio time stretching algorithm is available here: http://mpex.prosoniq.com/

An implementation of such a kind of application can be seen in the “WIT Music” video game by Nintendo, in which the Director is playing with an orchestra.

It is crucial to point out that the content of this application is entirely computer generated (as in simulated by a computer hardware/software system and not relating to an actual real life event being depicted), so it is completely different from the field of the present invention which is instead related to uninterrupted switchable audio-video streaming content (locally stored or received via network/Internet).

The desired level of interaction described in the present invention is obtained by means of an advanced gesture interface that calculates the relevant dimensional (space and time) data derived from the feeds (audio and visual positioning) and then interprets the user's input to determine the appropriate tridimensional path towards the desired direction (in 3D Space and/or Time). At which point an appropriate animation UI manages and produces the suitable screen transformations and effects in order to simulate the feeling of moving inside the space where the event being depicted occurs (or has occurred).

The steps being described here, can be performed on the audio-video sources than can be obtained via the methods described above in the summary of the invention paragraph. Such sources might be available offline to be pre-processed or could be streamed and interpreted in real-time by the server and/or the client.

The method is comprised of the following steps:
1. 3D Data Gathering:
Scene 3D Data—Analysis and/or Reconstruction
“Scene” is considered the tridimensional representation of the event and its locale as is possible to be determined via:
   Scene analysis from imaging data via for example: structure from motion type of algorithms (S.I.F.T.—S.L.A.M.—http://photosynth.net/etc. . . . ) or other comparable approach.
   3D sensors and 3D sensors augmented cameras (TOF [Time Of Flight]—http://www.illuminx.com—Microsoft Kinect, etc. . . . ).
   knowledge of cameras (and/or sensors) relevant parameters (which may include: interior and exterior camera parameters).
   virtual camera positions derived from otherwise obtained information (as described in Summary of the Invention).
   Scene analysis via audio positional information (if available for example when multiple audio feeds are captured).
Scene 3D Calibration
The purpose of this process is to infer a dynamic sample (per frame or any desired interval) of:
   camera position 3D coordinates for each of the available video feeds.
   camera lens information for each of the available video feeds.
   view direction vector for each of the available video feeds.
   positional audio data for each of the available audio feeds.
   determination of the Virtual Acoustic Environment of scene locale.
   global world scale coordinates of Scene (generally not dynamic).
      this is realized by introducing (human or other) scale references assumptions based on:
         knowledge of scene geometric invariants parts.
         user determination (measurement).
         human body tracking and recognition.
An alternative embodiment (described above) might add:
   full scene 3D reconstruction via augmented capture devices.
2. Data Representation:
Dynamic Representation of Scene 3D Data
In one possible embodiment this is an xml file that can be dynamically updated at the required intervals (frame-rate or otherwise)
   x y z coordinate of camera positions.
   direction vector.
   lens information.
   audio positioning.
   Virtual Acoustic Environment of scene locale.
   time coding information relative to audio and video.
   various formats of full scene 3D data representation.
3. Processing:
The data described above is processed via:
Scene Descriptor
This is the class that describes (2D 3D spatial layout and relations) the connection graph of the available vantage points of view. It also reads the Dynamic 4D Data (3D positioning plus Time Coding) information after it has been elaborated. The time-coded information (expressed in the appropriate format and intervals—e.g. frames or timecode or subsamples thereof) can be used to drive time altering actions by the users (or system—e.g. editing list) on the audio-video feeds.
Scene Mapper
Determines the topology configurations of the vantage points of view and of their respective Virtual Acoustic Environment configurations with all their relational connections. This determines the geometric configuration of the simulated 3D space (plane, sphere, complex surface, volume etc. . . . ) and of the possible transitional paths among points of view and their relative listening positions.
4. User Input:
Gesture based choice of vantage point of view playback of audio-video content.
Gesture based choice of time altered playback of audio-video content.
Selectable by the user among a programmable set of gestural interface actions, such as swipes, touches or others.
5. Gesture Mapper:
User input is processed and the Gesture Mapper assigns a path (among those available as instructed by the Scene Mapper) for performing the necessary tridimensional transformations to be applied to the current point of view (and listening position) to transition it into the one chosen by the users (or system—e.g. editing list). User input can also be mapped to the time coded information actions allowed, for example time scaling (slow motion or fast forward with or without audio pitch alteration) etc. . . .
6. Animation Interface and Output:
Animation transitional elements (audio and video) are assigned, triggered and rendered along with the appropriate audio-video feeds for the user (or system—e.g. editing list) desired points of view (and listening position) to the device appropriate output e.g. viewport (screen or 3D display)—speakers etc. . . .

The objective of having a virtually unlimited feeds without compromise in respects to the continuity of fruition of audio and video is challenging. It becomes even more challenging if we attempt to realize it using devices that have limited hardware resources such the aforementioned one in the preferred embodiment of the present invention.

Nonetheless, for the purpose of creating the desired perceptual effect, it is sufficient to provide the user with the feeling of having a nearly unlimited number vantage points of view constantly available. This is obtained in fact via the dynamic management of only a few of them (point of view) at any given time through an efficient code base.

So in the preferred embodiment of the present invention we are actually only managing two main view for the video feeds at any time (the minimum number that is necessary for animating transitions), and only a single audio which serves also as a basis for the time synchronization between all the available sources.

The actual sources though are in fact available in a number greater than two, and they are switched in the player, at any given moment, via the extensive utilization of uninterrupted switchable streaming techniques (encapsulating sources inside an array, switching to the destination feed exclusively when a key-frame is available so to not generate artifacts, using a common shared timeline, etc. . . . ).

In the described environment a user can, for example, interact with the player through a swipe or touch gesture. This allows her/him to freely switch among a great number of available video feeds where the transitions between subsequent choices are animated in the view-port in a planar fashion relative to the device screen space (for example being in a centered position a gesture of swipe right will produce a slide transition to a camera to the right) all of this happening while the show (audio-video) continues uninterrupted.

### DETAILED DESCRIPTION

The present invention overcomes the limitations of the prior. Methods and systems that implement the embodiments of the various features of the invention will now be described. The descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific detail. Well-known circuits, structures and techniques may not be shown in detail in order not to obscure the embodiments. For example, circuits may be shown in block diagrams in order not to obscure the embodiments in unnecessary detail.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage may represent one or more devices for storing data, including read-only memory (ROM), random access memory (RAM), magnetic disk storage mediums, optical storage mediums, flash memory devices and/or other machine readable mediums for storing information. The term “machine readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, or a combination thereof. When implemented in software, firmware, middleware or microcode, the program code or code segments to perform the necessary tasks may be stored in a machine-readable medium such as a storage medium or other storage(s). One or more than one processor may perform the necessary tasks in series, concurrently or in parallel. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted through a suitable means including memory sharing, message passing, token passing, network transmission, etc.

The system and method will now be disclosed in detail. Preferred embodiments will now be described more fully. Embodiments, however, may be embodied in many different forms and should not be construed as being limited to the embodiment set forth herein. Rather, this preferred embodiment is provided so that this disclosure will be thorough and complete, and will fully convey the scope to those skilled in the art.

As used herein, the term “and/or” includes any and all combinations of one or more of the associated listed items.

It will be understood that although the terms first, second, third, etc., may be used herein to describe various elements, components, Classes or methods, these elements, components, Classes or methods should not be limited by these terms. These terms are only used to distinguish one elements, components, Classes or methods from another element, component, Class or method.

For example, a first element, component, Class and/or method could be termed a second element, component, Class and/or method without departing from the teachings of example embodiments.

Spatially relative methods, such as “-(void)animateFromRight,” “-(void)animateFromLeft”, “-(void)animateFromTop”, “-(void)animateFromBottom”, and the like may be used herein for ease of description to describe the relationship of one method/Class and/or feature to another method/Class and/or feature, or other method(s)/Class(es) and/or feature(s).

It will be understood that the spatially relative terms are intended to encompass different orientations of the device in use or operation.

The terminology used herein is for the purpose of describing this preferred embodiment only and is not intended to be limiting. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, and/or components.

Unless otherwise defined, all terms (including technical and scientific terms) used herein have the same meaning as commonly understood by one of ordinary skill in the art to which preferred embodiment belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

In this description of the preferred embodiment we are using iOS sdk 3.2 for an Apple iPad application, which is available for registered developers at the website of said company.

For the single audio track we are using a singleton that is obtained using a macro header file (“SynthesizeSingleton.h”) written by Matt Gallagher, which is available at the following website link: http://cocoawithlove.com/2008/11/singletons-appdelegates-and-top-level.html.

The “SingleAudio” class is driving the timeline to which all video feeds refer for synchronization, in the preferred embodiment the audio file is loaded into the “Main Bundle” of the App also in the case that the video files are streamed over a network (i.e. Internet) to assure that user listening experience is unaffected by communication failures, but if it is not a strict requirement the audio track could be equally loaded over the net.

“SingleAudio” class header file is defined as follows:

“SingleAudio.h” Code starts below:

//
// SingleAudio.h
// iPov3
//
// Created by Antonio Rossi on 02/01/11.
// Copyright 2011 Yoctle Limited Limited. All rights reserved.
//
#import <Foundation/Foundation.h>
#import <AVFoundation/AVFoundation.h>
#import <CoreMedia/CoreMedia.h>
#import “SynthesizeSingleton.h”
@interface SingleAudio : NSObject {
AVPlayerItem *audioItem;
AVPlayer *audioPlayer;
CMTime *audioTime;}
@property (nonatomic, retain) AVPlayerItem *audioItem;
@property (nonatomic, retain) AVPlayer *audioPlayer;
// Class method to return an instance of GameController. This is needed
as this
// class is a singleton class + (SingleAudio *)sharedSingleAudio;
-(void)play;
-(void)syncUI;
-(CMTime)currentTime;
@end

“SingleAudio.h” code has finished here.

The implementation of “SingleAudio” class is descripted below.

“SingleAudio” class implementation code starts here:

//
// SingleAudio.m
// iPov3
//
// Created by Antonio Rossi on 02/01/11.
// Copyright 2011 Yoctle Limited Limited. All rights reserved.
//
#import “SingleAudio.h”
#import “CocosDenshion.h”
#import “SimpleAudioEngine.h”
@implementation SingleAudio
@synthesize audioItem;
@synthesize audioPlayer;
static const NSString *ItemStatusContext;
// Make this class a singleton class
SYNTHESIZE_SINGLETON_FOR_CLASS(SingleAudio);
-(id)init {
if ((self = [super init])) {
NSURL *audioFileURL = [[NSBundle mainBundle]
URLForResource:@“audio” withExtension:@“m4v”];
NSLog(@“loaded audio.m4v”);
AVURLAsset *audioAsset = [AVURLAsset
URLAssetWithURL:audioFileURL
options:nil];
self.audioItem = [AVPlayerItem playerItemWithAsset:audioAsset];
self.audioPlayer = [AVPlayer playerWithPlayerItem:audioItem];
[self.audioPlayer pause];
[[NSNotificationCenter defaultCenter] addObserver:self
selector:@selector(playerItemDidReachEnd:)
name:AVPlayerItemDidPlayToEndTimeNotification object:audioItem];
[self.audioItem addObserver:self forKeyPath:@“status” options:0
context:&ItemStatusContext]; }
return self; }
-(void)play {
[audioPlayer play];
NSLog(@“audio playing”); }
-(CMTime)currentTime {
return self.audioItem.currentTime; }
- (void)observeValueForKeyPath:(NSString *)keyPath ofObject:(id)object
change:(NSDictionary *)change context:(void *)context {
if (context == &ItemStatusContext) {
[self syncUI];
return; }
[super observeValueForKeyPath:keyPath ofObject:object change:change
context:context];
return; }
- (void)syncUI {
if ((audioPlayer.currentItem != nil) &&
([audioPlayer.currentItem status] ==
AVPlayerItemStatusReadyToPlay)) { }
else { }}
- (void)playerItemDidReachEnd:(NSNotification *)notification {
// bring again the show at the beginning and notify povs
[audioPlayer seekToTime:kCMTimeZero];
[[NSNotificationCenter defaultCenter]
postNotificationName:@“showDidReachEnd” object:self];
NSLog(@“show did reach end, sent notification”);}
@end

“SingleAudio” class implementation code finished.

The format and requirements of the content is managed by a class “SceneDescriptor”, in this implementation it has hard coded source files for loading the required video sources and all the basic graphic elements such as the thumbnails.

“SceneDescriptor” header file is as follows:

“SceneDescriptor” header code starts below:

//
// SceneDescriptor.h
// iPov3
//
// Created by Antonio Rossi on 01/01/11.
// Copyright 2011 Yoctle Limited Limited. All rights reserved.
//
#import <Foundation/Foundation.h>
#import <AVFoundation/AVFoundation.h>
@interface SceneDescriptor : NSObject {
NSArray *sourcesFileNames;
NSString *sourcesFileType;
NSArray *thumbnailsFileNames;
NSString *thumbnailsFileType;
NSMutableArray *stageFeedDistributor;
NSMutableArray *stageThumbnailsStreamsReaders;
AVPlayerItem *sourcePlayerItem;
int numberOfVideoFeeds;
int initialVideoFeed;}
@property (nonatomic, retain) NSMutableArray *stageFeedDistributor;
@property (nonatomic, retain) NSMutableArray
*stageThumbnailsStreamsReaders;
@property (nonatomic, retain) AVPlayerItem *sourcePlayerItem;
@property int numberOfVideoFeeds;
@property int initialVideoFeed;
-(id)initWithStageFiles;
@end

“SceneDescriptor” header code finished.

“SceneDescriptor” implementation code is as follows:

“SceneDescriptor” implementation code starts below:

#import “SceneDescriptor.h”
#import “Global.h”
@implementation SceneDescriptor
@synthesize stageFeedDistributor, stageThumbnailsStreamsReaders;
@synthesize sourcePlayerItem;
@synthesize numberOfVideoFeeds;
@synthesize initialVideoFeed;
-(id)init {
return [self initWithStageFiles];}
-(id)initWithStageFiles {
if (self = [super init]) {
// create the array with stage filenames
sourcesFileNames = [NSArray arrayWithObjects:@“sx”, @“hi”, @“my”,
@“ph”, @“dx”, nil];
sourcesFileType = @“m4v”;
thumbnailsFileNames = [NSArray arrayWithObjects:@“sx-thumb”,
@“hithumb”,
@“my-thumb”, @“ph-thumb”, @“dx-thumb”, nil];
thumbnailsFileType = @“mov”;
NSLog(@“loading stage...”);
// init the array of sources
stageFeedDistributor = [[NSMutableArray alloc]
initWithCapacity:[sourcesFileNames count]];
stageThumbnailsStreamsReaders = [[NSMutableArray alloc]
initWithCapacity:[thumbnailsFileNames count]];
// init properties
numberOfVideoFeeds = [sourcesFileNames count];
NSLog(@“here we have %d sources”, numberOfVideoFeeds);
initialVideoFeed = INITIAL_VIDEO_FEED;
NSLog(@“initial point of view of this stage: %d”,
initialVideoFeed);}
return self;}
-(NSMutableArray*)stageThumbnailsStreamsReaders {
for (int i = 0; i < numberOfVideoFeeds; i++) {
// set the thumbnails array of assets
NSURL *thumbnailFileURL = [[NSBundle mainBundle]
URLForResource:[thumbnailsFileNames objectAtIndex:i]
withExtension:thumbnailsFileType];
AVURLAsset *thumbnailAsset = [[AVURLAsset alloc]
initWithURL:thumbnailFileURL
options:[NSDictionary dictionaryWithObject:[NSNumber
numberWithBool:NO]
forKey:AVURLAssetPreferPreciseDurationAndTimingKey]];
[stageThumbnailsStreamsReaders addObject:thumbnailAsset];
//[thumbnailFileURL release];}
return stageThumbnailsStreamsReaders;}
-(NSMutableArray*)stageFeedDistributor {
for (int i = 0; i < numberOfVideoFeeds; i++) {
// set the sources array of playerItems
NSLog(@“loading %i files of type %@”, [sourcesFileNames count],
sourcesFileType);
NSURL *sourceFileURL = [[NSBundle mainBundle]
URLForResource:[sourcesFileNames objectAtIndex:i]
withExtension:sourcesFileType];
AVURLAsset *sourceAsset = [[AVURLAsset alloc]
initWithURL:sourceFileURL
options:[NSDictionary dictionaryWithObject:[NSNumber
numberWithBool:YES]
forKey:AVURLAssetPreferPreciseDurationAndTimingKey]];
self.sourcePlayerItem = [AVPlayerItem
playerItemWithAsset:sourceAsset];
[stageFeedDistributor addObject:sourcePlayerItem];
[sourceAsset release];
//[sourceFileURL release]; }
return stageFeedDistributor; }
-(void) dealloc {
NSLog(@“deallocating stage initializer”);
[stageFeedDistributor dealloc];
[stageThumbnailsStreamsReaders dealloc];
NSLog(@“deallocating playerItems initializer”);
[super dealloc];}
@end

“SceneDescriptor” implementation code finished.

A “UserSessionManager” class coordinates relationships between user gestures and devices status and orientation, it is receiving inputs from the GUI (graphical user interface), it alternates two objects of a “StreamProducer” class in order to manage the presentation on the screen device of two alternating “StreamConsumer” objects, one user visible video at a given time and another one operating not visible in background that is provided for animating transitions, this last one swapping its role with the first at the end of a transition.

The alternation between the two “StreamProducer” objects realize the effect of unlimited switchable video feeds presented on the screen device, which are selectable by gestures given by the user, such as swipes or touches on the screen device.

The header file of “UserSessionManager” class is shown below.

“UserSessionManager” header file code starts here:

//
// UserSessionManager.h
// iPov3
//
// Created by Antonio Rossi on 07/01/11.
// Copyright 2011 Yoctle Limited Limited. All rights reserved.
//
#import <UIKit/UIKit.h>
#import <QuartzCore/QuartzCore.h>
#import <iAd/iAd.h>
@class StreamProducer;
@class SingleAudio;
@class PlayerControlsViewController;
@class SplashViewController;
@class BannerViewController;
@class InfoViewController;
@interface UserSessionManager : UIViewController
<ADBannerViewDelegate,
UIWebViewDelegate> {
StreamProducer *firstStreamProducer;
StreamProducer *secondStreamProducer;
SplashViewController *splashViewController;
BannerViewController *bannerViewController;
InfoViewController *infoViewController;
SingleAudio *sharedSingleAudio;
BOOL isOtherPlayer;
BOOL okToSwitch;
BOOL playerControlsShown;
BOOL hidePlayerControlsWithAnimation;
BOOL switchHasBeenReset;
int newPointOfView;
PlayerControlsViewController *playerControls;
UIDeviceOrientation lastOrientation;}
@property (nonatomic, retain) IBOutlet StreamProducer
*firstStreamProducer;
@property (nonatomic, retain) IBOutlet StreamProducer
*secondStreamProducer;
@property (nonatomic, retain) IBOutlet
PlayerControlsViewController
*playerControls;
-(void)switchFeed;
-(void)loadStage;
-(void)assignFeed;
-(void)swipeCanBeCanceled;
-(void)pauseShow;
-(void)resumeShow;
-(void)returnToShow;
@end

“UserSessionManager” header file code finished.

“UserSessionManager” class has a method defined as “-(void)assignFeed”; this is an algorithm that maps navigation rules between available feeds and user interaction via gestures.

Suppose we have a certain number of feeds referring to multiple view of a given event, we can establish that the a user viewing a central camera and swiping to the right will go to a right camera, and back if swiping to the opposite direction. Method “-(void)switchFeed” implements the logic for the two alternating “StreamProducer” class objects, of which only one is presented to the user at a given time, being the other always available for the animating transition as said before.

“UserSessionManager” class has two methods named “-(void)showPlayerControls” and “-(void)hidePlayerControls:(NSTimer*)theTimer”, which are managing the presentation on screen device of a GUI in which thumbnails of the available feeds can be shown, providing the user other interface elements with which he can interacts.

As said before, in “UserSessionManager” the video feed are constantly synchronized to the timeline of the singleton “SingleAudio” class, for example in the switching phase or in the show management methods.

“UserSessionManager” class further has other methods related to “show management”, the timing of the presentation of elements and the acquisition of user gestures, the managing of ads presented on screen, the managing of various phases of animating transition.

“UserSessionManager” class implementation code is as follows.

“UserSessionManager” implementation code start below.

“UserSessionManager” implementation code finished.

“StreamProducer” class is invoked by “UserSessionManager” to produce the two main alternating objects for presenting video to the user. It contains the “Gesture Mapper” implementation that in the preferred embodiment is responsible for mapping the appropriate animations generated by the “Animation Engine” to user gesture actions. Methods named “-(void)animateContent(FromLeft/FromRight/FronTop/FromBottom)” to a transition happening from a first player to a second player.

“StreamProducer” header file code is as follows.

“StreamProducer” header code starts below:

//
// StreamProducer.h
// iPov3
//
// Created by Antonio Rossi on 01/01/11.
// Copyright 2011 Yoctle Limited Limited. All rights reserved.
//
#import <UIKit/UIKit.h>
#import <AVFoundation/AVFoundation.h>
typedef enum {
UserWantsCameraSwitchUp = 0,
UserWantsCameraSwitchRight,
UserWantsCameraSwitchDown,
UserWantsCameraSwitchLeft,
UserWantsCameraSwitchMAX,
} UserWantsCameraSwitch;
@class SceneDescriptor;
@class StreamConsumer;
/*
This class manage a UIView having a StreanConsumer object that
loads content by different sources loaded by class Theatre Descriptor
*/
@interface StreamProducer : UIViewController
<UIGestureRecognizerDelegate> {
NSMutableArray *FeedDistributor;
int numberOfVideoFeeds;
int currentVideoFeed;
int newVideoFeed;
StreamConsumer *videoFeed;
AVPlayer *streamProducer;
AVPlayerItem *streamReader;
UserWantsCameraSwitch userWantsCameraSwitch;
CATransition *animation;
UIDeviceOrientation lastOrientation;
BOOL gotSwipe;}
@property (nonatomic, retain) AVPlayer *streamProducer;
@property (nonatomic, retain) AVPlayerItem *streamReader;
@property (nonatomic, retain) IBOutlet UIButton *playButton;
@property int numberOfVideoFeeds;
@property int currentVideoFeed;
@property int newVideoFeed;
@property UserWantsCameraSwitch userWantsCameraSwitch;
@property (nonatomic, retain) CATransition *animation;
@property (nonatomic) BOOL gotSwipe;
-(void)animateContent;
-(void)animateContentFromLeft;
-(void)animateContentFromRight;
-(void)animateContentFromTop;
-(void)animateContentFromBottom;
-(void)syncUI;
-(void)loadStage;
-(void)fireTouch;
-(AVPlayerItem*)getFeed:(int)aFeed;
@end

“StreamProducer” header code finished.

“StreamProducer” is a derived class of UlViewController; is function is such that when one of the objects is presented on screen it is designated as the first responder to user driven events, as a consequence it manages the user interaction in the given coordinates system (method “-(void)gestureMapper:(UISwipeGestureRecognizer*)recognizer”.

Furthermore, utilizing the information relative to the device orientation, “StreamProducer” also manages the required animations needed when the user is moving (choosing a different vantage point of view) to another feed, the logic of which is defined in the -(void)animateContent(FromLeft/FromRight/FronTop/FromBottom) methods.

“StreamProducer” implementation code is as follows:

“StreamProducer” implementation code starts below:

“StreamProducer” header code and implementation code finished.

A further element of the GUI which gives additional choices for a user giving gestures is a panel of player controls, which manages the presentation on screen of thumbnails related to the available video feeds, this element is managed by a class named “PlayerControlsViewController”.

“PlayerControlsViewController” header file is as follows.

“PlayerControlsViewController” header file code begins below.

//
// PlayerControlsViewController.h
// iPov3
//
// Created by Antonio Rossi on 07/01/11.
// Copyright 2011 Yoctle Limited Limited. All rights reserved.
//
#import <UIKit/UIKit.h>
#import <AVFoundation/AVFoundation.h>
#import <CoreMedia/CoreMedia.h>
#import “Global.h”
@class SceneDescriptor;
@class SingleAudio;
@interface PlayerControlsViewController : UIViewController {
CGFloat playerControlsHeight;
int pointsOfView;
NSTimer *animationUpdate;
SingleAudio *sharedSingleAudio;
// array container for player items, using thumbnails property of class
Stage in this class
NSMutableArray *thumbnailsAssets;
BOOL shownOnScreen;
BOOL thumbnailsAreClean;
BOOL demoInfoRequested;
int thumbNailsUpdateFrequency;
int generateThumbnailAtIndex;
NSArray *imageGenerators;
NSMutableArray *splashThumbnailsImagesArray;
NSArray *visibleThumbnailsArray;
AVAssetImageGenerator *thumbZeroGenerator;
AVAssetImageGenerator *thumbOneGenerator;
AVAssetImageGenerator *thumbTwoGenerator;
AVAssetImageGenerator *thumbThreeGenerator;
AVAssetImageGenerator *thumbFourGenerator;
IBOutlet UIImageView *thumbZero;
IBOutlet UIImageView *thumbOne;
IBOutlet UIImageView *thumbTwo;
IBOutlet UIImageView *thumbThree;
IBOutlet UIImageView *thumbFour;
IBOutlet UIButton *demoInfoButton;
UIImage *iPovLogo;
SceneDescriptor *stage;}
@property (nonatomic) BOOL shownOnScreen;
@property (nonatomic, retain) NSArray *imageGenerators;
@property (nonatomic, retain) NSMutableArray *thumbnailsAssets;
@property (nonatomic, retain) NSArray *visibleThumbnailsArray;
@property (nonatomic) BOOL thumbnailsAreClean;
@property (nonatomic, retain) SceneDescriptor *stage;
@property (nonatomic, retain) IBOutlet UIButton *demoInfoButton;
-(IBAction)pauseButton:(id)sender;
-(IBAction)playButton:(id)sender;
-(IBAction)demoInfoButton:(id)sender;
-(IBAction)rewindButton:(id)sender;
-(IBAction)contentInfoButton:(id)sender;
-(void)loadStage;
-(void)setIPOV;
-(void)showChoosenPointOfView:(int)pointOfView;
-(void)setControlsOnScreenPortrait;
-(void)setControlsOnScreenLandscape;
-(void)getPositionOnScreen;
-(void)updateThumbnailsStartingFromIndex:(int)index;
-(void)infoDismissed;
@end

“PlayerControlsViewController” header file code finished.

A couple of methos of “PlayerControlsViewController” (-(void)setControlsOnScreenPortrait/-(void) setControlsOnScreenLandscape) are responsible for animating the view and managing the thumbnails along with other buttons available to user interaction, such for example “play” and “pause”. In the current implementation this view represents only a portion of the visible area which, in some circumstances, overlaps the user selected video feed; a particular care is then taken to dock it constantly in a position which poses minimum interference with the principal view (the selected feed served to the user).

The iPad has a limit regarding the number of views playing videos that can be presented contemporary on the screen device, so to manage an unlimited number of thumbnail related to the desired feeds which is desiderable to allow the user to choose, in “PlayerControlsViewController” a method is present named “(void)updateThumbnailsStartingFromIndex:(int)index” which generates an image for a given thumbnail at a given showtime using an asynchronously recursive algorithm, and assign it to the UIImageView visible area for that thumbnail. Subsequently the algorithm recursively proceeds with the following required thumbnails at the given index. This procedure allows the capability of generating a nearly unlimited number thumbnails for the available feeds without incurring in the inherent limits of the video player for what is possible to show to the user at a certain time.

“PlayerControlsViewController” class implementation code is as follows.

“PlayerControlsViewController” implementation code starts below.

//
// PlayerControlsViewController.m
// C-iPov
//
// Created by Antonio Rossi on 07/01/11.
// Copyright 2011 Yoctle Limited Limited. All rights reserved.
//
#import “PlayerControlsViewController.h”
#import “Global.h”
#import “PlayerControlsView.h”
#import “SceneDescriptor.h”
#import “SingleAudio.h”
@implementation PlayerControlsViewController
@synthesize shownOnScreen;
@synthesize imageGenerators;
@synthesize stage;
@synthesize thumbnailsAssets;
@synthesize thumbnailsAreClean;
@synthesize visibleThumbnailsArray;
@synthesize demoInfoButton;
#pragma mark -
#pragma mark initialization
-(void)loadStage {
// initialize the properties
stage = [[SceneDescriptor alloc] initWithStageFiles];
thumbnailsAssets = [[stage stageThumbnailsStreamsReaders] copy];
[stage release];
stage = nil;
splashThumbnailsImagesArray = [NSMutableArray
arrayWithCapacity:CAMERAS_ON_STAGE];
[splashThumbnailsImagesArray retain];
NSMutableArray *temporaryImageGenerators = [NSMutableArray
arrayWithCapacity:CAMERAS_ON_STAGE];
for (int i = 0; i < CAMERAS_ON_STAGE; i++) {
NSLog(@“starting generating content for thumbnails”);
[splashThumbnailsImagesArray addObject:[UIImage
imageWithContentsOfFile:[[NSBundle mainBundle]
pathForResource:@“iPOV-43”
ofType:@“png”]]];
[temporaryImageGenerators addObject:[AVAssetImageGenerator
assetImageGeneratorWithAsset:[thumbnailsAssets objectAtIndex:i]]];}
imageGenerators = [[[NSArray alloc]
initWithArray:temporaryImageGenerators] copy];
NSLog(@“thumbnails array have been allocated”);
thumbNailsUpdateFrequency = 1;
iPovLogo = [UIImage imageWithContentsOfFile:[[NSBundle
mainBundle]
pathForResource:@“iPOV-43” ofType:@“png”]];
[iPovLogo retain];
[self setIPOV];}
-(void)setIPOV {NSLog(@“now thumbnails are iPov logo image”);
thumbnailsAreClean = YES;
if (visibleThumbnailsArray == nil) {
[thumbZero setImage:iPovLogo];;
[thumbOne setImage:iPovLogo];
[thumbTwo setImage:iPovLogo];
[thumbThree setImage:iPovLogo];
[thumbFour setImage:iPovLogo];
visibleThumbnailsArray = [[NSArray alloc]
initWithObjects:thumbZero, thumbOne, thumbTwo, thumbThree,
thumbFour,nil];}
//visibleThumbnailsArray = [[NSArray alloc] initWithObjects:thumbZero,
thumbOne, thumbTwo, thumbThree, thumbFour,nil];}
-(void)viewDidLoad {[super viewDidLoad];
playerControlsHeight = PLAYER_CONTROLS_HEIGHT;
sharedSingleAudio = [SingleAudio sharedSingleAudio];
animationUpdate = [NSTimer scheduledTimerWithTimeInterval:0.5
target:self selector:@selector(updateAnimation:) userInfo:nil
repeats:YES];
thumbnailsAreClean = YES;
demoInfoRequested = NO;}
#pragma mark -
#pragma mark update animations
-(void)updateAnimation:(NSTimer*)theTimer {
if (shownOnScreen) {
//NSLog(@“entering in thumbnails generation algorithm”);
generateThumbnailAtIndex = 0;
[self updateThumbnailsStartingFromIndex:0];}
if (!shownOnScreen && !thumbnailsAreClean) {
NSLog(@“IPOV IPOV IPOV IPOV IPOV IPOV IPOV IPOV ”);
[self setIPOV];}
if (demoInfoRequested) {
if (demoInfoButton.state == UIControlStateNormal) {
demoInfoButton.highlighted = YES;
} else if (demoInfoButton.state == UIControlStateHighlighted) {
demoInfoButton.highlighted = NO;}}}
#pragma mark -
#pragma mark thumbnails view management
-(void)showChoosenPointOfView:(int)pointOfView {
for (int i = 0; i < [visibleThumbnailsArray count]; i++) {
[[visibleThumbnailsArray objectAtIndex:i] setHighlighted:NO];}
[[visibleThumbnailsArray objectAtIndex:pointOfView]
setHighlightedImage:[UIImage
imageWithContentsOfFile:[[NSBundle mainBundle]
pathForResource:@“iPOV-43” ofType:@“png”]]];
[[visibleThumbnailsArray objectAtIndex:pointOfView]
setHighlighted:YES];}
-(void)updateThumbnailsStartingFromIndex:(int)index {
if (generateThumbnailAtIndex < CAMERAS_ON_STAGE) {
CMTime showTime = [[SingleAudio sharedSingleAudio] currentTime];
NSArray *frameAtShowTime = [NSArray arrayWithObjects:[NSValue
valueWithCMTime:showTime], nil];
//NSLog(@“recursive algorithm for thumbnails generation working
on thumbnail number:%d”, index);
[[imageGenerators objectAtIndex:index]
generateCGImagesAsynchronouslyForTimes:frameAtShowTime
completionHandler:\hat{ }(CMTime requestedTime, CGImageRef
image,
CMTime actualTime,
AVAssetImageGeneratorResult result, NSError *error){
//NSLog(@“evaluating thumbnails images”);
if (result == AVAssetImageGeneratorSucceeded) {
//NSLog(@“could generate an image for thumbnail at
index: %d”, index);
[splashThumbnailsImagesArray
replaceObjectAtIndex:index withObject:[UIImage
imageWithCGImage:image]];
[[visibleThumbnailsArray objectAtIndex:index]
setImage:[splashThumbnailsImagesArray objectAtIndex:index]];
generateThumbnailAtIndex++;
if (generateThumbnailAtIndex <= CAMERAS_ON_STAGE) {
[self
updateThumbnailsStartingFromIndex:generateThumbnailAtIndex];}}
if (result == AVAssetImageGeneratorFailed) {
//NSLog(@“could not generate an image for thumbnail
at index:%d:, error:%@”, index, error);
generateThumbnailAtIndex++;
if (generateThumbnailAtIndex <= CAMERAS_ON_STAGE) {
[self
updateThumbnailsStartingFromIndex:generateThumbnailAtIndex];}}
if (result == AVAssetImageGeneratorCancelled) {
//NSLog(@“image generator canceled for thumbnail at
index:%d, reason:%@”, index, error);
generateThumbnail AtIndex++;
if (generateThumbnailAtIndex <= CAMERAS_ON_STAGE) {
[self
updateThumbnailsStartingFromIndex:generateThumbnailAtIndex];}}}];}
else {
//NSLog(@“placing thumbnails”);
//NSLog(@“thumbnails generated”);
thumbnailsAreClean = NO;}}
#pragma mark -
#pragma mark user interface rotation management
-(void)getPositionOnScreen {CGPoint origin = self.view.frame.origin;
CGSize size = self.view.frame.size;CGPoint center = self.view.center;
NSLog(@“playerControlsView positioning is as follows, x: %f − y: %f −
width:%f − height:%f, center.x:%f, center.y:%f”, origin.x, origin.y,
size.width, size.height, center.x, center.y);}
-(void)setControlsOnScreenPortrait {CGPoint superViewcenter =
self.view.superview.center;CGRect screenRect= [[UIScreen
mainScreen] bounds];
CGPoint newCenter =
CGPointMake(superViewcenter.x,screenRect.size.height −
playerControlsHeight / 2);[self.view
setCenter:newCenter];NSLog(@“playerControlsView has been setup
in portrait”);}
-(void)setControlsOnScreenLandscape {
CGPoint superViewcenter = self.view.superview.center;
//CGRect screenRect= [[UIScreen mainScreen] bounds];
//CGPoint newCenter = CGPointMake(superViewcenter.y,
screenRect.size.width − playerControlsHeight / 2);
CGPoint newCenter = CGPointMake(superViewcenter.y,
playerControlsHeight/ 2);
[self.view setCenter:newCenter];
NSLog(@“playerControlsView has been setup in landscape”);}
#pragma mark -
#pragma mark user interaction
-(void)touchesBegan:(NSSet *)touches withEvent:(UIEvent *)event {
UITouch *touch = [touches anyObject];
if ([touch view] == thumbZero) {[[NSNotificationCenter
defaultCenter]
postNotificationName:@“thumbZero” object:self];}
else if ([touch view] == thumbOne) {[[NSNotificationCenter
defaultCenter]
postNotificationName:@“thumbOne” object:self];}
else if ([touch view] == thumbTwo) {[[NSNotificationCenter
defaultCenter]
postNotificationName:@“thumbTwo” object:self];}
else if ([touch view] == thumbThree) {[[NSNotificationCenter
defaultCenter]
postNotificationName:@“thumbThree” object:self];}
else if ([touch view] == thumbFour) {[[NSNotificationCenter
defaultCenter]
postNotificationName:@“thumbFour” object:self];}
NSLog(@“user clicked a thumbnail”);}
-(IBAction)playButton:(id)sender {
NSLog(@“user clicked play”);
[[NSNotificationCenter defaultCenter]
postNotificationName:@“playButton” object:self];
}
-(IBAction)pauseButton:(id)sended {NSLog(@“user clicked pause”);
[[NSNotificationCenter defaultCenter]
postNotificationName:@“pauseButton”
object:self]; }
-(IBAction)demoInfoButton:(id)sender {demoInfoRequested = YES;
[[NSNotificationCenter defaultCenter]
postNotificationName:@“demoInfoButton”
object:self]; }
-(void)infoDismissed {demoInfoRequested = NO; [demoInfoButton
setHighlighted:NO];}
-(IBAction)contentInfoButton:(id)sender {[[NSNotificationCenter
defaultCenter]
postNotificationName:@“contentInfoButton” object:self];}
-(IBAction)rewindButton:(id)sender {[[NSNotificationCenter
defaultCenter]
postNotificationName:@“rewindButton” object:self];}
#pragma mark -
#pragma mark application lifeCycle
- (BOOL)shouldAutorotateToInterfaceOrientation:(UIInterfaceOrientation)
interfaceOrientation {
// Overriden to allow any orientation.
return YES;}
- (void)didReceiveMemoryWarning {
// Releases the view if it doesn't have a superview.
[super didReceiveMemoryWarning];
// Release any cached data, images, etc. that aren't in use.}
- (void)viewDidUnload {[super viewDidUnload];
// Release any retained subviews of the main view.
// e.g. self.myOutlet = nil;}
- (void)dealloc {[super dealloc];}
@end
“PlayerControlsViewController” implementation code finished.

What has been described is a new and improved system and method for a remote control for portable electronic devices that is simple operate and operable with a single hand, overcoming the limitations and disadvantages inherent in the related art.

Although the present invention has been described with a degree of particularity, it is understood that the present disclosure has been made by way of example. As various changes could be made in the above description without departing from the scope of the invention, it is intended that all matter contained in the above description or shown in the accompanying drawings shall be illustrative and not used in a limiting sense.

What is claimed is:

1. A method of manipulating a audio video visualization in a multi dimensional virtual environment implemented in a computer system having a display unit for displaying the virtual environment and a gesture driven interface, said method manipulating the visualization in response to predetermined user gestures and movements identified by the gesture driven interface, comprising the steps of:
receiving user gestural input by a capable hardware device;
a client software object capable of playing a plurality of multimedia streaming sources;
said multimedia streaming sources are corresponding to digitally encoded files related to an event;
said multimedia streaming sources corresponding to different viewpoints of said event;
said viewpoints having means for a connection graph related to their positioning in space;
said software initially playing a selection of a first multimedia streaming source from said plurality of multimedia streaming sources;
said client software object having means for uninterrupted switching from said initially playing selection of a first multimedia streaming source to a new selection of a new multimedia streaming source selected from said plurality of multimedia streaming sources;
said client software object having means for receiving a switch request;
said client software object having means for relating said gestural input to said switch request;
said client object having means for relating user gestures to said connection graph; and
said client object having means for visualizing transitions in space among said multimedia streaming sources, said transitions related to said connection graph so as to visualize a transition, upon receiving said gestural input for said switch request to said new selection of said new multimedia streaming source, using said connection graph and performing an uninterrupted switching of said multimedia streaming sources.

2. The method of claim 1, wherein said transitions comprise tridimensional transformations.

3. The method of claim 1, wherein said plurality of multimedia streaming sources comprise at least an audio content.

4. The method of claim 1, wherein said client software object is receiving at least two video streaming sources for animating transition.

5. The method of claim 4, wherein said user gestures comprise swipe gestures.

6. The method of claim 5, wherein a single audio perform a basis synchronization for said plurality of multimedia streaming sources.

7. The method of claim 6, wherein said transitions are animated in a planar fashion relative to said computer system device screen.

8. The method of claim 1, wherein said connection graph comprise camera position 3D coordinates.

9. The method of claim 1, wherein said plurality of multimedia streaming sources are accessed by said client software object over a network.
